(19) United States
(12) Patent Application Publication
(10) Pub. No.: US 2006/0068770 A1
(43) Pub. Date: Mar. 30, 2006

(54) Automatic call system and method, and an alert engine and an activation stage used in the system

(76) Inventors: Ludovic Carlier, Lannion (FR); Bernard Savina, Lannion (FR); Samuel Liard, Chartres De Bretagne (FR)

Correspondence Address: YOUNG & THOMPSON, 745 SOUTH 23RD STREET, 2ND FLOOR, ARLINGTON, VA, 22202, US

(21) Appl. No.: 11/210,875

(22) Filed: Aug. 25, 2005

(30) Foreign Application Priority Data
Aug. 25, 2004 (FR) 04 09088

(51) Int. Cl. H04M 3/00

(52) U.S. Cl. 455/418; 455/412.1

(57) ABSTRACT

A system for automatically calling a set of receivers includes an alert engine for commanding calls to the receivers of the set in accordance with an alert procedure defining at least one conditional transition between stages of calling a list of receivers. The alert procedure is stored in a file that can be modified independently of the alert engine.

The present invention relates to an automatic call system and method, and to an alert engine and an activation station used in the system.

Prior art automatic call systems include an alert engine suitable for causing calls to be set up to receivers in accordance with an alert procedure defining at least one conditional transition between stages of calling receivers from a list.

Those systems are particularly useful for alerting persons such as rescuers in the event of an accident, for example.

In those prior art systems, the alert procedure is integrated into the code of the alert engine and forms therewith one and the same program. Accordingly, if a user wishes to modify the alert procedure, the code of the alert engine must be modified. Those prior art systems are therefore difficult to adapt to the requirements of each user.

The invention aims to remedy this drawback by proposing an automatic call system that is easy to adapt to the requirements of each user.

The invention consists in an automatic call system in which the alert procedure is stored in a file that can be modified independently of the alert engine.

In the automatic call system of the invention, the alert procedure is stored in a file that can be modified independently of the alert engine. Accordingly, if it is only the alert procedure that needs to be changed, it is no longer necessary to modify the code of the alert engine.

Embodiments of the above system may comprise one or more of the following features:
the alert engine commands the execution of a new call stage if a condition associated with an anticipated transition is evaluated as true and without waiting for the end of the execution of a preceding call stage and, after the anticipated transition, the call engine executes the preceding call stage and the new call stage in parallel without interrupting the execution of the preceding call stage;
the anticipated transition is defined in the alert procedure;
the system includes an autodialer under the control of the alert engine for calling each receiver from a list of receivers and for sending tracking information on the state of progress of the calls to the alert engine, which evaluates conditions associated with transitions defined by the alert procedure as a function of that tracking information;
the alert procedure is written in a content description language that uses tags and is derived from the Standard Generalized Markup Language;
the alert engine interprets tags contained in the alert procedure;
the alert procedure includes an anticipated transition tag marking the beginning of the definition of an anticipated transition enabling the triggering of a new call stage even before a preceding call stage has terminated;
the alert procedure includes a waiting-for-a-command tag marking the beginning of the definition of a stage of waiting for a command which, when it is executed by the alert engine, enables the alert engine to wait for a condition to be satisfied before proceeding to a call stage;
the alert engine simultaneously executes a plurality of call stages belonging to different alert procedures;
the system further includes:
   a plurality of alert procedures stored in files modifiable independently of the alert engine, and
   a station for activating the execution of one of those alert procedures that is connected to the engine via a long-distance information transmission network and selects the alert procedure to be executed by the alert engine;
the station sends the alert engine either the whole of an alert procedure to be executed or else an identifier of a prestored alert procedure to be executed, in response to which the alert engine triggers the execution of either the alert procedure that was sent or the prestored alert procedure corresponding to the identifier that was sent.

The invention also provides an alert engine adapted to be used in the above automatic call system.

The invention further provides a method of automatically calling a set of receivers, the method comprising a stage of causing calls to be set up to the receivers of said set in accordance with an alert procedure defining at least one conditional transition between stages of calling receivers from a list. The method includes a stage of storing an alert procedure in a file that can be modified independently of the alert module. The method may also include a stage of writing the alert procedure in a content description language that uses tags and is derived from the Standard Generalized Markup Language (SGML).

The invention will be better understood on reading the following description, which is given by way of example only and with reference to the drawings, in which:

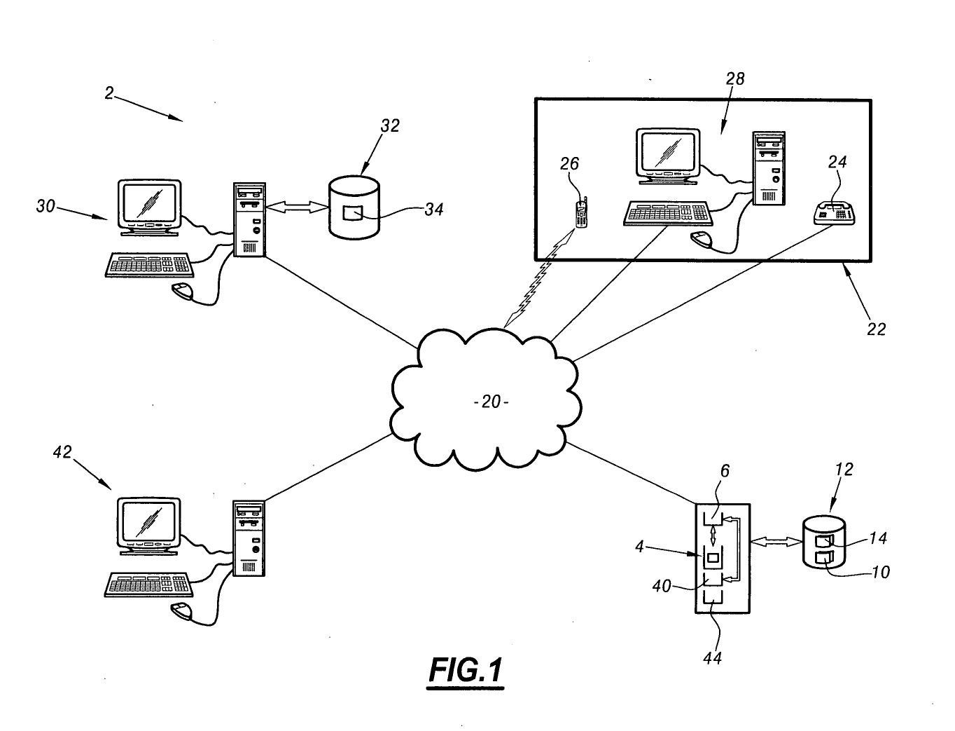

FIG. 1 is a diagram of the architecture of an automatic call system,

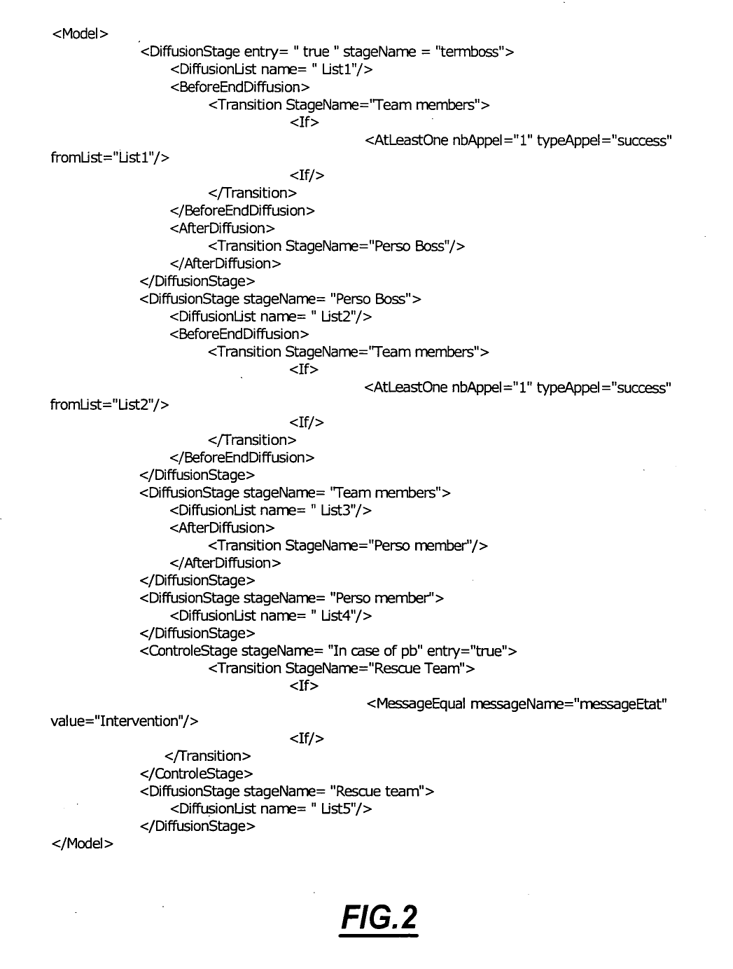

FIG. 2 shows the content of a file in which an alert procedure is stored,

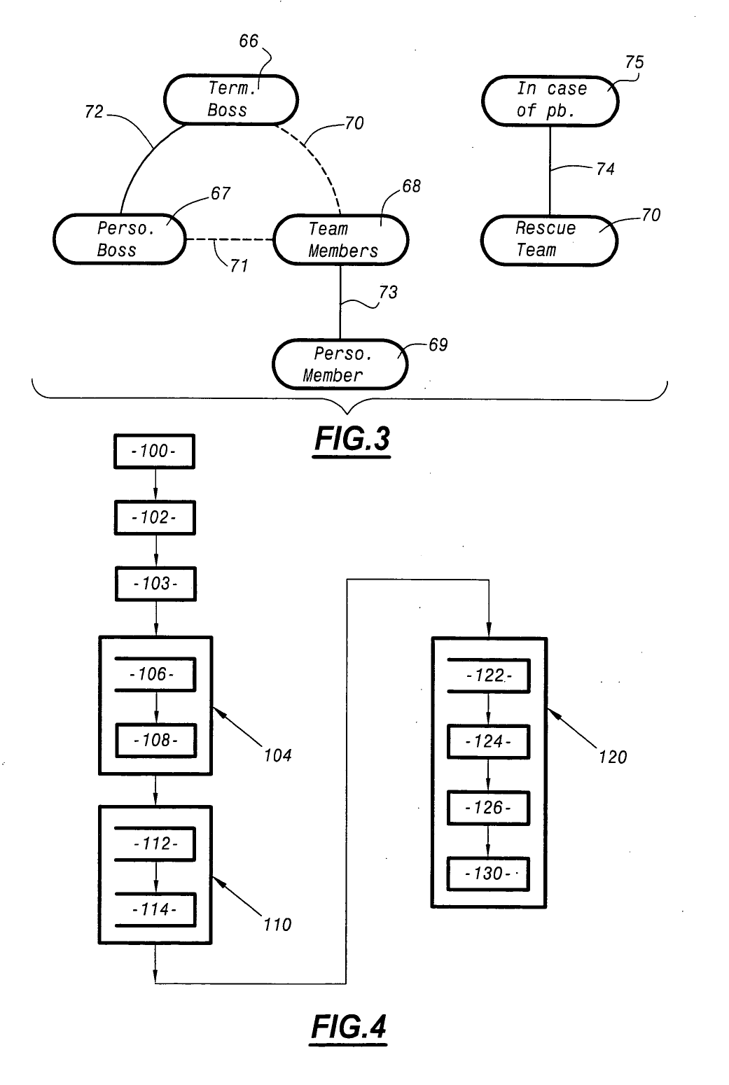

FIG. 3 is a flowchart corresponding to the content of the FIG. 2 file, and

FIG. 4 is a flowchart of an automatic call procedure.

FIG. 1 shows an automatic call system 2 that includes an alert engine 4 associated with an autodialer 6.

The alert engine 4 interprets and then executes one or more alert procedures; if there are two or more alert procedures they are executed simultaneously. For example, the engine 4 is based on a conventional programmable computer that executes instructions stored on a information storage medium, when those instructions are executed by the computer. To this end, the storage medium contains instructions for executing the FIG. 4 method.

Alert procedures in progress are stored in a database 10 stored in a memory 12 that also contains files 14 containing prestored alert procedures, prestored call lists, and where applicable prestored messages. The prestored alert procedures, call lists, and messages are respectively associated with an alert procedure identifier, a call list identifier, and a message identifier.

An alert procedure defines conditional transitions between call stages during which the autodialer 6 calls receivers in a list, for example a prestored list. The conditional transitions define one or more conditions for moving from one call stage to the next. These transitions between two call stages are either executed or not executed by the engine 4 as a function of information tracking the execution status of the current call stage. An example of an alert procedure is described in detail below with reference to FIGS. 2 and 3.

The autodialer 6 calls a set 22 of receivers corresponding to a list of calls via a long-distance information transmission network 20, for example a public switched telephone network PSTN. For example, the set 22 of receivers includes one or more fixed telephones 24, one or more mobile telephones 26, and one or more computers 28.

The call list used by the autodialer 6 includes details for contacting each of the receivers of the set 22 via the network 20. For example, the call list includes the telephone number of each fixed telephone 24 or mobile telephone 26, and the e-mail address of the user of each computer 28.

The autodialer 6 is able to call a plurality of the receivers whose details are included in the call list, either one after the other or simultaneously.

The autodialer 6 also sends back to the engine 4 call tracking information representing the state of progress of the calls to be effected. For example, the call tracking information that the autodialer 6 sends back to the engine 4 includes the call list and, for each specified receiver, information on the state of progress of the call to that receiver. That state of progress may take three values, for example: “in progress”, “failed” and “succeeded”. The “in progress” value means that the call is being set up, the “failed” value means that the receiver has not been contacted, and the “succeeded” value means that the receiver has been called successfully.

A station 30 for activating the execution of an alert procedure by the engine 4 is connected to the engine 4 via the network 20 and enables a user to select the alert procedure that the engine 4 is to execute. To this end, the station 30 transmits an identifier of an alert procedure prestored in one of the files 14 of the engine 4, for example. In the present example, it also sends the engine 4 an alert procedure that is stored locally. To this end, the station 30 is connected to a memory 32 containing one or more alert procedures 34.

The station 30 enables a user to select a message to be broadcast to all the receivers. In a similar manner to that described for the alert procedure, the station 30 sends to the engine 4 an identifier of a prestored message in the memory 12 and/or the message to be broadcast to the receivers via the network 20. The message sent to the engine 4 is prestored in the memory 32, for example.

The station 30 is based on a standard computer equipped with an Internet browser for communicating with the engine 4, for example.

The system 2 also includes an Internet server 40, a remote consultation station 42, and an input module 44.

The server 40 provides remote tracking of the progress of an alert procedure. To this end, it is connected to the autodialer 6 to receive the call tracking information and enables the station 42 to consult that information. The station 42 is typically a computer equipped with an Internet browser.

The module 44 is of standard design and is used to enter new call procedures, call lists, or messages, and to store them in the files 14.

For the purposes of the present example, and to simplify the explanation, the engine 4, the autodialer 6, the server 40, and the module 44 are installed in the same data processing server, which is connected to the memory 12.

FIG. 2 shows an example of an alert procedure contained in one of the files 14 and FIG. 3 shows the FIG. 2 alert procedure in the form of a flowchart.

To simplify the configuration of the system 2, the call procedures are written in a language that uses tags and is derived from the Standard Generalized Markup Language (SGML). To be more precise, in the present example, the call procedure is written in the extensible Markup Language (XML).

Each alert procedure is bracketed between an opening tag or marker <Model> and a closing tag or marker </Model>.

Tags <DiffusionStage> and </DiffusionStage> placed between the tags <Model> and </Model> respectively define the beginning and the end of the definition of a call stage.

The tag <DiffusionStage> may contain one or two attributes or no attribute. The first attribute “entry” signifies that this call stage is an entry point into the alert procedure when it assumes the value “True”, in which case the engine 4 begins by executing that call stage. The second attribute “StageName” defines the name of the stage. In the present example, five call stages are defined in the alert procedure and are respectively designated “TermBoss”, “PersoBoss”, “Team member”, “PersoMember” and “Rescue Team”. In FIG. 3, these stages are numbers 66 to 70 in the above order.

Thereafter, the definition of a call stage includes at least one tag <DiffusionList> for identifying the call list to be used in that stage that includes for this purpose an attribute “name” for defining the name of the call list. For example, the following tag:
<diffusionlist name=“list1”/>
   means that the list of receivers to be called during the call stage is contained in the file whose name is “list1”.

Thereafter, the definition of a call stage may include the definition of one or more conditional or unconditional transitions to another call stage. For example, the alert procedure here includes opening tags <BeforeEndDiffusion> and closing tags </BeforeEndDiffusion> between which are defined anticipated transitions to other call stages. To be more precise, the <BeforeEndDiffusion> tags have the particular feature of defining an anticipated transition that enables the engine 4 to execute the next stage without stopping execution of the preceding stage. Such anticipated transitions between two stages are represented by dashed lines in FIG. 3. For example, the alert procedure includes an anticipated conditional transition 70 between the stages 66 and 68 and an anticipated conditional transition 71 between the stages 67 and 68.

The definition of the transitions 70 and 71 is placed between an opening tag <Transition> and a closing tag </Transition>. The <Transition> tag includes an attribute “StageName” for indicating to which call stage the transition is to be effected if a condition is evaluated as true. For example, the tag <Transition StageName=“Team members”> means that the transition is to be effected to call stage 68.

The condition that triggers the transition is placed between the <Transition> and </Transition> tags. Here, this condition is bracketed by an opening tag <If> and a closing tag <If/>. The tag placed between the <If> and <If/> tags defines the condition for which the conditional transition is activated. Here, by way of example, the condition is that at least one call from a list of calls must have been completed successfully for the transition to the next stage to be activated.

In FIG. 2 this condition corresponds to the sign tag <AtLeastOne nbAppel=“1” typeAppel=“success” from List=“List1”>, which has three attributes. The first attribute “nbAppel” specifies the call number, the second attribute “typeAppel” specifies the state of progress of the call, and the third attribute “fromList” specifies the name of the call list concerned.

To be more precise, here, the transition 70 is effected when a receiver from the list “List1” has been called successfully and the transition 71 is effected when a receiver from the list “List2” has been called successfully.

The alert procedures also include unconditional transitions that are always executed during execution of the alert procedure.

These unconditional transitions are not associated with a condition. Here, they are defined by an opening tag <AfterDiffusion> and a closing tag </AfterDiffusion>. These transitions correspond to a systematic transition to a call stage following the end of execution of the preceding call stage. Between the <AfterDiffusion> and </AfterDiffusion> tags, the <Transition> tag defines the name of the call stage to which the transition is effected. Here, the alert procedure defines two of these unconditional transitions, which are represented by solid lines 72, 73 in FIG. 3.

Finally, the FIG. 2 alert procedure includes a stage 75 of awaiting a command defined between tags <ContrôleStage> and </ContrôleStage>. The <ContrôleStage> tag includes the same attributes as the <DiffusionStage> tag. For example, in the particular instance of FIG. 2, the stage 75 “In case of pb” corresponds to a second entry point into the alert procedure.

During the stage 75, the engine 4 takes no action and merely waits for the condition associated with the transition 74 to be evaluated as true.

The condition associated with the transition 74 is defined by the tag <MessageEqual messageName=“messageEtat”>, which means that the transition is effected when a received message whose name is specified by the attribute “messageName” takes the value specified by the attribute “value”. In the FIG. 2 alert procedure described here, the received message must have the name “messageEtat” and take the value “intervention” for the transition to be effected. The transition is represented by the line 74 in FIG. 3.

The operation of the system 2 is described next with reference to FIG. 4 in the particular situation in which the alert procedure to be executed is that shown in FIG. 2.

Initially, during a stage 100, using the module 44, an operator of the system 2 writes the FIG. 2 alert procedure in XML using predefined tags. Once the alert procedure has been written, during a stage 102, it is stored in a file 14 that is stored in the memory 12.

During a stage 103, the operator enters and stores in the memory 12 one or more call lists and one or more messages to be broadcast.

If necessary, the station 30 sends an intervention request to the engine 4 during a stage 104 which includes an operation 106 which selects the alert procedure(s) to be executed. To be more precise, in the operation 106, the station 30 sends the engine 4 either an identifier of a prestored alert procedure to be executed or the alert procedure itself. The stage 104 further includes an operation 108 which selects the message to be broadcast to the various receivers. In a similar manner to the operation 106, the message to be broadcast is selected by the station 30 sending the engine 4 either an identifier of a prestored message or the message to be broadcast itself.

During a stage 110, in response to an intervention request, the engine 4 interprets the content of the files 14 corresponding to the alert procedures selected during the stage 104. The stage 110 includes in particular an operation 112 in which the stages of the selected alert procedures are stored in the database 10 and an operation 114 in which the call lists referenced by the selected call procedures are stored in the database 12.

Thereafter, during a stage 120, the engine 4 executes in parallel all of the call procedures stored in the database 10. For example, in the particular case of the FIG. 2 alert procedure, the engine 4 begins by executing the stages 66 and 75 simultaneously.

To be more precise, during the stage 66, according to what is indicated in the alert procedure, the engine 4 executes an operation 122 that sends the call list “list1” to the autodialer 6 and commands the autodialer 6 to begin calling the receivers whose details are in that list.

At regular intervals, the engine 4 executes an operation 124 which interrogates the autodialer 6, which sends call tracking information back to the engine 4.

The engine 4 executes an operation 126 which evaluates the various conditional transitions, allowing for the most recently received tracking information. If the condition associated with a conditional transition is evaluated as “true” then the engine 4 begins to execute the next stage in the alert procedure. For example, as soon as the engine 4 is informed by the autodialer 6 that one of the receivers from the list “list1” has been called successfully, it begins to execute the call stage 68 whilst continuing to execute the call stage 66.

When a call stage is completed, the engine 4 begins to execute the next call stage designated by the tag <AfterDiffusion>, if it exists. For example, at the end of the call stage 66 the engine 4 automatically proceeds to executing the call stage 67.

The engine 4 also executes an operation 130 that evaluates the conditional transitions for leaving a stage of waiting for a command.

For example, in the case of the FIG. 2 alert procedure, the engine 4 tests at regular intervals to see if a message “messageEtat” has taken the value “Intervention”. If so, the engine 4 begins immediately to execute the step 70. If not, the engine 4 continues to wait. The value of the message “messageEtat” can be modified from the station 30, for example. Thus the engine 4 tracks the alert procedure defined in a file 14 stage by stage by regularly testing the conditions associated with the conditional transitions and effects those transitions only if the associated condition is evaluated as “true”.

To be more precise, the alert engine simultaneously tests the conditions of the conditional transitions of all the alert procedures currently being executed in parallel and simultaneously commands the execution of all the call stages that are currently active, independently of the alert procedure to which those transitions and/or stages belong. Thus the engine 4 is able to execute a plurality of alert procedures simultaneously on its own.

It will be noted that it is possible to modify an alert procedure without modifying the operation of the engine 4. This facilitates adapting the operation of the engine 4 to the requirements of clients.

Because of the anticipated transitions, it is possible to accelerate the execution of an alert procedure, since it is possible to begin the execution of a new call stage of that alert procedure without waiting for a preceding call stage to finish.

The use of a content description language that employs tags simplifies the configuration of the system 2 because it avoids the use of programming stages consisting in writing and then compiling a program. Since the tags are predefined, the user does not need to know in detail how the engine 4 works. Moreover, the use of tags for defining call stages and stages of waiting for a command simplifies the writing of alert procedures.

The system 2 is described here in the particular situation in which it includes only one alert engine. Alternatively, it includes a plurality of identical alert engines installed in the same server or in respective servers.

The receivers may be machines of any kind or incorporated into machines of any kind. In this case, the alert message may be accompanied by instructions for controlling that machine. For example, the system may be used to trigger the switching on of video cameras, sensors (for example temperature, pressure or level sensors or detectors of chemical products, etc.) or a decontamination system. The system may also be used to trigger the stopping of sensitive machinery, the disconnection of non-vital elements of a network, such as an electricity distribution network, or the isolation of dangerous or sensitive objects.

1. A system for automatically calling a set of receivers, the system comprising an alert engine for causing calls to be set up to the receivers of said set in accordance with an alert procedure defining at least one conditional transition between stages of calling a list of receivers, wherein the alert procedure is stored in a file that can be modified independently of the alert engine.

2. A system according to claim 1, wherein the alert engine commands the execution of a new call stage if a condition associated with an anticipated transition is evaluated as true and without waiting for the end of the execution of a preceding call stage and, after the anticipated transition, the call engine executes the preceding call stage and the new call stage in parallel without interrupting the execution of the preceding call stage.

3. A system according to claim 2, wherein the anticipated transition is defined in the alert procedure.

4. A system according to claim 1, wherein it includes an autodialer under the control of the alert engine and which calls each receiver from a list of receivers and sends tracking information on the state of progress of the calls to the alert engine, which evaluates the conditions associated with transitions defined by the alert procedure as a function of that tracking information.

5. A system according to claim 1, wherein the alert procedure is written in a content description language that uses tags and is derived from the Standard Generalized Markup Language.

6. A system according to claim 5, wherein the alert engine interprets the tags contained in the alert procedure.

7. A system according to claim 5, wherein the alert procedure includes an anticipated transition tag marking the beginning of the definition of an anticipated transition enabling the triggering of a new call stage even before a preceding call stage has terminated.

8. A system according to claim 5, wherein the alert procedure includes a waiting-for-a-command tag marking the beginning of the definition of a stage of waiting for a command which, when it is executed by the alert engine, enables the alert engine to wait for a condition to be satisfied before proceeding to a call stage.

9. A system according to claim 1, wherein the alert engine simultaneously executes a plurality of call stages belonging to different alert procedures.

10. A system according to claim 1, wherein it further includes:
a plurality of alert procedures stored in files modifiable independently of the alert engine, and
a station for activating the execution of one of those alert procedures that is connected to the engine via a long-distance information transmission network and selects the alert procedure to be executed by the alert engine.

11. A system according to claim 10, wherein the station sends the alert engine either the whole of an alert procedure to be executed or else an identifier of a prestored alert procedure to be executed, in response to which the alert engine triggers the execution of the alert procedure that was sent or the prestored alert procedure corresponding to the identifier that was sent.

12. An alert engine adapted to be used in a system according to claim 1 and to command calls to the receivers of said set in accordance with the alert procedure, which defines at least one additional transition between stages of calling receivers from a list of receivers, wherein the alert engine executes an alert procedure stored in a file modifiable independently of the alert engine.

13. An activation station adapted to be used in a system according to claim 10, wherein:
the station is connected to the alert engine via a long-distance information transmission network, and
the station selects the alert procedure to be executed by the alert engine and activates the execution of the selected alert procedure.

14. A method of automatically calling a set of receivers, the method comprising a stage of commanding calls to the receivers of said set in accordance with an alert procedure defining at least one conditional transition between stages of calling a list of receivers, wherein it includes a stage of storing an alert procedure in a file that can be modified independently of an alert engine for executing the command stage.

15. A method according to claim 14, wherein it includes a stage of writing the alert procedure in a content description language that uses tags and is derived from the Standard Generalized Markup Language.

16. An alert procedure adapted to be executed in a system according to claim 1, the alert procedure being executable by the alert engine for causing calls to be set up to receivers and defining at least one conditional transition between stages of calling a list of receivers, wherein the alert procedure can be stored in a file that can be modified independently of the alert engine.

17. A procedure according to claim 16, wherein it defines an anticipated transition which, when it is evaluated as true, enables the alert engine to cause a new call stage to be executed without waiting for the end of the execution of a preceding call stage, so that after the anticipated transition the call engine executes the preceding call stage and the new call stage in parallel without interrupting the execution of the preceding call stage.

18. A procedure according to claim 16, wherein the conditions associated with transitions defined in the alert procedure are a function of tracking information on the state of progress of the calls sent to the alert engine by an autodialer.

19. An alert procedure according to claim 16, wherein it is written in a content description language that uses tags and is derived from the Standard Generalized Markup Language.

20. An alert procedure according to claim 19, wherein it includes an anticipated transition tag marking the beginning of the definition of an anticipated transition enabling the triggering of a new call stage before a preceding call stage has terminated.

21. An alert procedure according to claim 19, wherein it includes a waiting-for-a-command tag marking the beginning of the definition of a stage of waiting for a command which, when it is executed by the alert engine, enables the alert engine to wait for a condition to be satisfied before proceeding with a call stage.

22. A memory which contains an alert procedure according to claim 16.

23. A computer program which includes instructions for executing an alert procedure according to claim 16 when those instructions are executed by an electronic computer.
